(19) United States
(12) Patent Application Publication
(10) Pub. No.: US 2020/0143711 A1
(43) Pub. Date: May 7, 2020

(54) PRODUCT PACKAGE, TAG AND BLANK THEREFOR

(71) Applicant: WestRock MWV, LLC, Atlanta, GA (US)

(72) Inventors: Matthew E. Zacherle, Chesterfield, VA (US); Cullen B. Rosenbriend, Richmond, VA (US)

(21) Appl. No.: 16/671,240

(22) Filed: Nov. 1, 2019

Related U.S. Application Data
(60) Provisional application No. 62/754,959, filed on Nov. 2, 2018.

(51) Int. Cl. G09F 1/06; B65D 73/00; G09F 23/00

(52) U.S. Cl. CPC G09F 1/06; G09F 23/00; B65D 73/0078

(57) ABSTRACT

Aspects of the disclosure relate to a package, a product tag and a blank for forming the product tag. An aspect of the invention provides a package comprising a display card mounted to a product. The display card comprises a front panel, a rear panel and a pair of easel panels. The pair of easel panels together with at least one of the front and rear panels form a first tubular structure for information display. The product comprises at least one arm and the display card comprises at least one second tubular structure mounted to the at least one arm.

### REFERENCE TO RELATED APPLICATION

This application claims the benefit of priority under 35 U.S.C. §119(e) of U.S. Provisional Patent Application Ser. No. 62/754959 filed on Nov. 2, 2018, which is hereby incorporated by reference in its entirety.

### TECHNICAL FIELD

The present invention relates to product packaging, to product tags or labels and to blanks for forming the same. More specifically, but not exclusively, the invention relates to a carrier providing a display card for mounting a product thereto and to a blank for forming the display card.

### BACKGROUND

In the field of packaging it is known to provide product tags or labels for mounting to articles or products. Product Tags are well known in the art and are useful for display of product information to consumer, display of the articles in a retail environment and enabling consumers to transport, store and access the product.

It is desirable to expose some or all of the product while on display to a consumer to allow inspection of the product and it is desirable to maximize the visual or aesthetic impact the package has upon the consumer, it is further desirable to provide the consumer with information about the product without hindering the consumer's ability to inspect the product. It is also desirable that the product tag is resistant to tampering, removal or separation from the product.

The present invention seeks to provide an improvement in product packaging, typically formed from paperboard or the like.

### SUMMARY

A first aspect of the present disclosure provides a package comprising a display card mounted to a product. The display card comprises a front panel, a rear panel and a pair of easel panels. The pair of easel panels together with at least one of the front and rear panels form a first tubular structure for information display. The product comprises at least one arm and the display card comprises at least one second tubular structure mounted to said at least one arm.

One advantage of the present disclosure is that the front panel, rear panel and tubular structures form a billboard. The billboard is three dimensional, it comprises a plurality of differently oriented planes, such that information is readily viewed from different viewpoint or orientations.

Optionally, the at least one second tubular structure is disposed about the at least one arm so as to substantially encircle the least one arm.

Optionally, the at least one arm comprise a shaft and a handle.

Optionally, the product comprises a pair of arms.

Optionally, the display card is mounted to at least one of the pair of arms.

Optionally, the display card is mounted between the pair of arms.

Optionally, the at least one second tubular structure is formed from a plurality of sleeve panels which in an erected condition form a tube having a cross-sectional shape approximating the cross-sectional shape of the at least one arm.

Optionally, the at least one second tubular structure is mounted on the at least one arm between a pair of end stops so as to inhibit removal of the display card from the product.

Optionally, the pair of easel panels comprises an end panel and a brace panel. The brace panel may be hinged to the front panel or to the rear panel.

Optionally, the end panel is hingedly connected to the brace panel.

Optionally, the first and second tubular structures are secured in an erected condition simultaneously by securing the front and rear panels together.

Optionally, at least one of the first and second tubular structures comprises a securing panel secured between front and rear panels.

Optionally, the first tubular structure comprises at least one securing panel secured between front and rear panels.

Optionally, the display card comprises a securing panel hingedly connected to the brace panel.

Optionally, at least one of the first and second tubular structures is hingedly connected to one of the front and rear panels.

Optionally, at least one of the first and second tubular structures is hingedly connected to each of the front and rear panels.

Optionally, at least one of the first and second tubular structures comprises a plurality of panels, and wherein a first end of the plurality of panels is hingedly connected to the front panel and a second end of the plurality of panels is hingedly connected to the rear panel.

Optionally, each or all of the first and second tubular structures is hingedly connected to one of the front and rear panels. The first and second tubular structures may be hingedly connected to the front panel.

A second aspect of the present disclosure provides a blank for forming a display card. The blank comprises a plurality of panels including a front panel, a rear panel and a pair of easel panels. The pair of easel panels together with at least one of the front and rear panels are arranged to form a first tubular structure for information display in a setup condition. The blank comprises a plurality of sleeve forming panels for forming at least one second tubular structure for mounting the display card to a product.

Optionally, the plurality of sleeve forming panels are hingedly connected in a linear series.

Optionally, the plurality of sleeve forming panels are hingedly connected to at least one of the front and rear panels.

Optionally, the plurality of sleeve forming panels are hingedly connected to each of the front and rear panels.

Optionally, the plurality of sleeve forming panels interconnect the front and rear panels.

Optionally, the plurality of sleeve forming panels are hingedly connected to at least one of the front and rear panels along a first edge thereof and the pair of easel panels are hingedly connected to said one of the front and rear panels along a second adjacent edge thereof.

Optionally, a first one of the pair of easel panels is hingedly connected to at least one of the front and rear panels. The first one of the pair of easel panels may be hingedly connected to a second one of the pair of easel panels.

Optionally, a second one of the pair of easel panels is hingedly connected to a securing panel.

Optionally, the blank is formed from a paperboard substrate having a tear resistant layer.

Optionally, the product is a pair of bolt cutters.

Within the scope of this application it is envisaged or intended that the various aspects, embodiments, examples, features and alternatives set out in the preceding paragraphs, in the claims and/or in the following description and drawings may be considered or taken independently or in any combination thereof.

Features or elements described in connection with, or relation to, one embodiment are applicable to all embodiments unless there is an incompatibility of features. One or more features or elements from one embodiment may be incorporated into, or combined with, any of the other embodiments disclosed herein, said features or elements extracted from said one embodiment may be included in addition to, or in replacement of one or more features or elements of said other embodiment.

A feature, or combination of features, of an embodiment disclosed herein may be extracted in isolation from other features of that embodiment. Alternatively, a feature, or combination of features, of an embodiment may be omitted from that embodiment.

### BRIEF DESCRIPTION OF THE DRAWINGS

Embodiments of the invention will now be described with reference to the accompanying drawings, in which:

FIG. 1 is a plan view from above of a blank for forming a product package according to a first embodiment;

FIG. 2 is a perspective view from above of a product package formed from the blank of FIG. 1;

FIG. 3 is a perspective view from below of a product package formed from the blank of FIG. 1;

FIG. 4 is a perspective view of the product package of FIG. 2 which is mounted to a product; and

FIG. 5 is a perspective view of a plurality of products each having the product package of FIG. 2 mounted thereto.

### DETAILED DESCRIPTION OF EMBODIMENTS

Detailed descriptions of specific embodiments of the product package, tag and blank are disclosed herein. It will be understood that the disclosed embodiments are merely examples of the way in which certain aspects of the invention can be implemented and do not represent an exhaustive list of all of the ways the invention may be embodied. As used herein, the word “exemplary” is used expansively to refer to embodiments that serve as illustrations, specimens, models, or patterns. Indeed, it will be understood that the product packages, tags and blanks described herein may be embodied in various and alternative forms. The Figures are not necessarily to scale and some features may be exaggerated or minimised to show details of particular components. Well-known components, materials or methods are not necessarily described in great detail in order to avoid obscuring the present disclosure. Any specific structural and functional details disclosed herein are not to be interpreted as limiting, but merely as a basis for the claims and as a representative basis for teaching one skilled in the art to variously employ the invention.

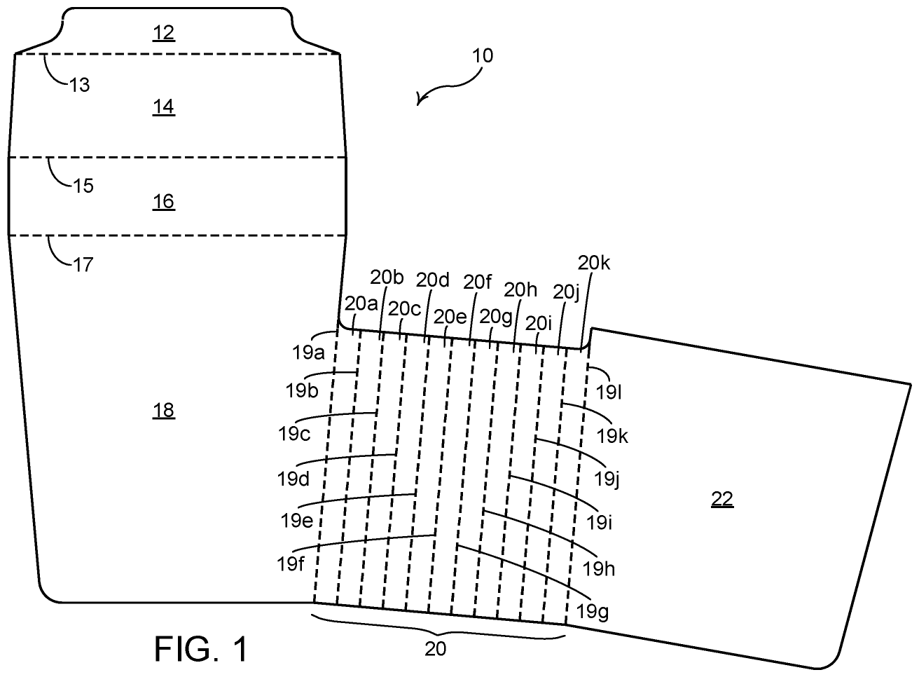

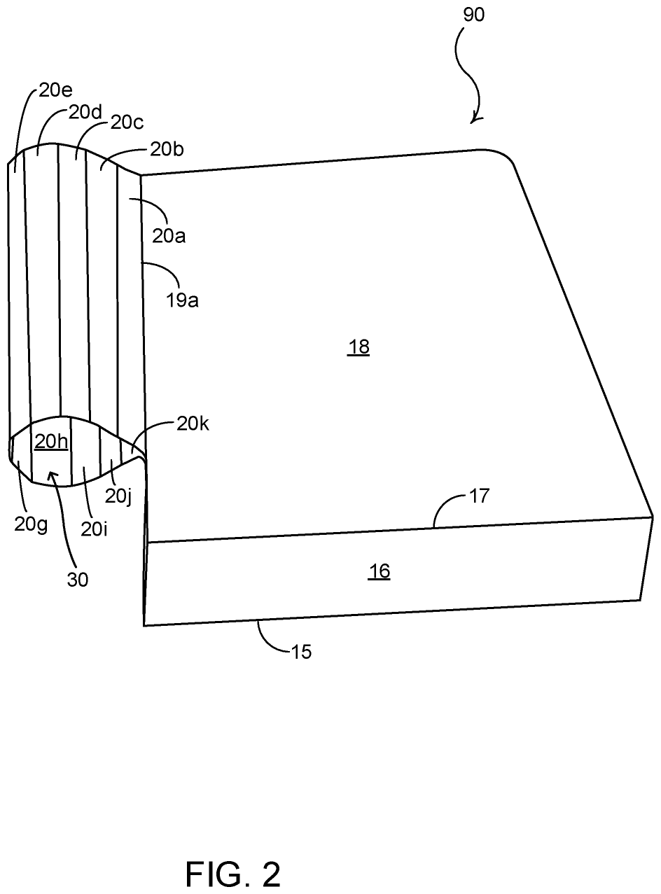

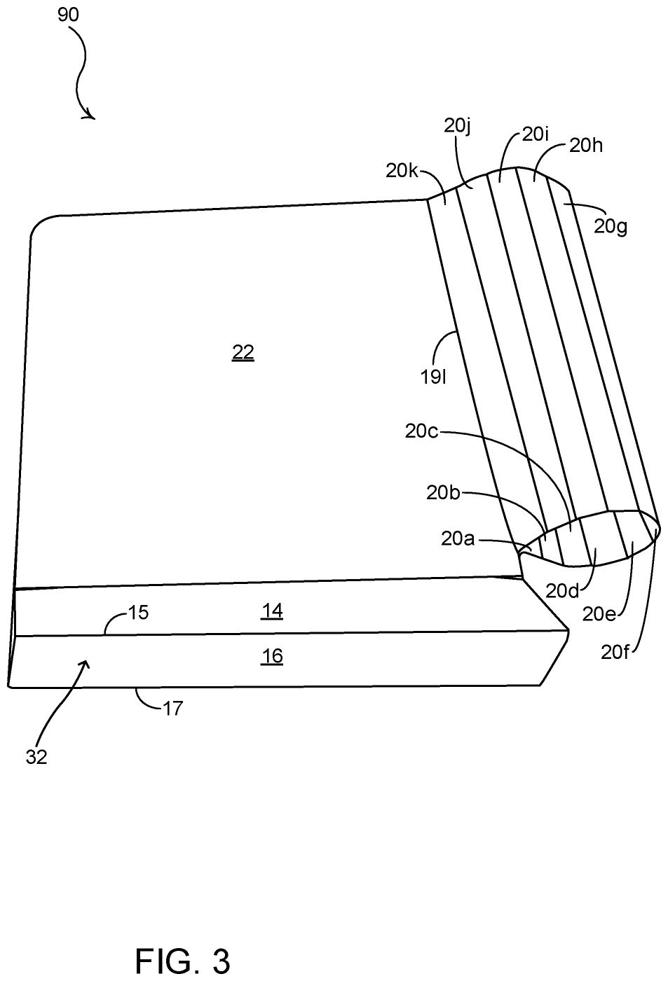

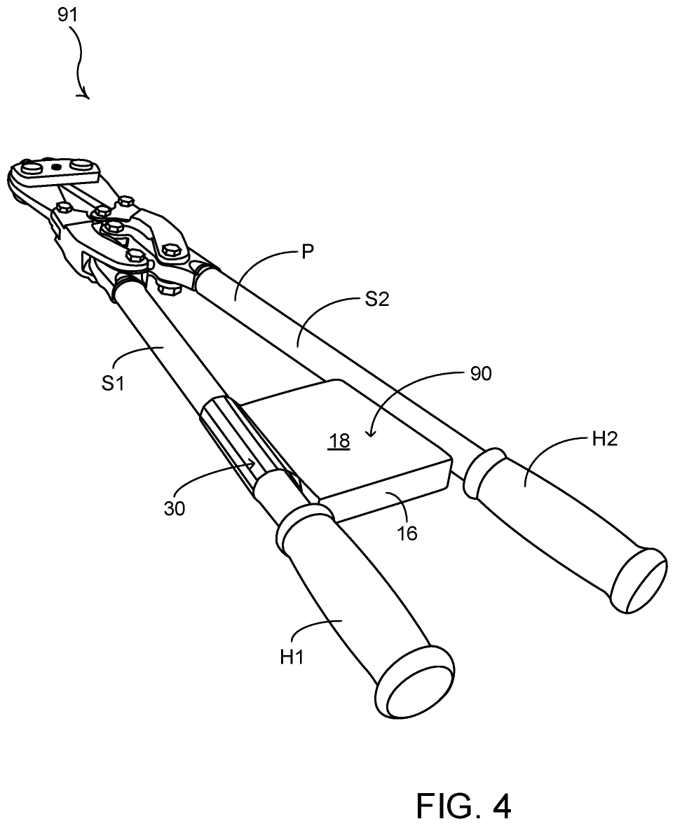

Referring to FIG. 1, there is shown a plan view of a blank 10 capable of forming a packaging structure 90 in the form of a display card (also referred to herein as a tag or label), as shown in FIGS. 2 and 3, for mounting to a primary product such as, but not limited to, a hand tool in the form of a bolt cutter, hereinafter also referred to as article P, as shown in FIG. 4.

The blank 10 is formed from a sheet of suitable substrate. It is to be understood that, as used herein, the term “suitable substrate” includes all manner of foldable sheet material such as paperboard, corrugated board, cardboard, plastic, combinations thereof, and the like. It should be recognised that one or other numbers of blanks may be employed, where suitable, for example, to provide the carrier structure described in more detail below.

The packaging structure 90 described herein may be formed from a sheet material such as paperboard, which may be made of or coated with materials to increase its strength. An example of such a sheet material is tear-resistant NATRALOCK® paperboard made by WestRock Company. It should be noted that the tear resistant materials may be provided by more than one layer, to help improve the tear-resistance of the package. Typically, one surface of the sheet material may have different characteristics to the other surface. For example, the surface of the sheet material that faces outwardly from a finished package may be particularly smooth and may have a coating such as a clay coating or other surface treatment to provide good printability. The surface of the sheet material that faces inwardly may, on the other hand, be provided with a coating, a layer, a treatment or be otherwise prepared to provide properties such as one or more of tear-resistance, good glue-ability, heat sealability, or other desired functional properties.

The tear resistant layer may be disposed over the uncoated side of the paperboard substrate and may be formed of polymeric material and secured to the substrate. The tear resistant layer imparts toughness to the laminate structure. Suitable tear resistant materials may include, but not be limited to, tear resistant laminated sheet material, e.g., NATRALOCK®, which may include a layer of an n-axially oriented film, e.g. MYLAR®, which is a bi-axially oriented polyester, oriented nylon, cross-laminated polyolefin or high density polyolefin. The orientation and cross-laminated structure of these materials contribute to the tear resistant characteristic. Also, tear resistance may be attributed to the chemical nature of the tear resistant material such as extruded metallocene-catalysed polyethylene (mPE).

Alternatively, the tear resistant layer may be a layer of linear low-density polyethylene (LLDPE). In embodiments where linear low-density polyethylene (LLDPE) or mPE is used, it is not necessary to incorporate an adhesive layer. Other suitable materials having a high level of tear resistance may also be used.

The adhesive layer may be formed of polyolefin material such as a low-density polyethylene (LDPE). The adhesive layer may be placed between the substrate and the tear resistant layer to secure the tear resistant layer to the substrate.

Turning to FIG. 1, there is illustrated a blank 10 for forming a display card 90 (see FIG. 2) according to a first embodiment. The blank 10 comprises a pair of main panels 18, 22, for forming a front panel 18 and a rear panel 22 of a display card structure.

The pair of main panels 18, 22 are hingedly connected together by a plurality of sleeve forming panels 20. The illustrated embodiment comprises eleven sleeve panels 20a to 20k.

The plurality of sleeve forming panels 20 interconnects the front panel 18 and the rear panel 22.

A first sleeve panel 20a is hingedly connected to a first side edge of the front panel 18 by a first hinged connection in the form of a fold line 19a. A second sleeve panel 20b is hingedly connected, along a first edge, to the first sleeve panel 20b by a second hinged connection in the form of a fold line 19b. A third sleeve panel 20c is hingedly connected, along a first edge, to the second sleeve panel 20b by a third hinged connection in the form of a fold line 19c. A fourth sleeve panel 20d is hingedly connected, along a first edge, to the third sleeve panel 20c by a fourth hinged connection in the form of a fold line 19d. A fifth sleeve panel 20e is hingedly connected, along a first edge, to the fourth sleeve panel 20d by a fifth hinged connection in the form of a fold line 19e. A sixth sleeve panel 20f is hingedly connected, along a first edge, to the fifth sleeve panel 20e by a sixth hinged connection in the form of a fold line 19f. A seventh sleeve panel 20g is hingedly connected, along a first edge, to the sixth sleeve panel 20f by a seventh hinged connection in the form of a fold line 19g. An eighth sleeve panel 20h is hingedly connected, along a first edge, to the seventh sleeve panel 20g by an eighth hinged connection in the form of a fold line 19h. A ninth sleeve panel 20i is hingedly connected, along a first edge, to the eighth sleeve panel 20h by a ninth hinged connection in the form of a fold line 19i. A tenth sleeve panel 20j is hingedly connected, along a first edge, to the tenth sleeve panel 20i by a ninth hinged connection in the form of a fold line 19j. An eleventh sleeve panel 20k is hingedly connected, along a first edge, to the tenth sleeve panel 20j by an eleventh hinged connection in the form of a fold line 19k.

The eleventh sleeve panel 20k is hingedly connected, along a second edge, to a side edge of the rear panel 22 by a twelfth hinged connection in the form of a fold line 191.

An end panel 16 is hingedly connected to a first end edge of the front panel 18 by a hinged connection in the form of a fold line 17. The first end edge is disposed adjacent to the first side edge of the front panel 18.

The blank 10 comprises a brace panel 14 for forming a strut or brace between the end panel 16 and the front panel 18. The brace panel 14 maintains the end panel 16 at a non-zero angle to the front panel 18 in an erected condition. That is to say the end panel 16 is non-coplanar, divergently arranged, with respect to the front panel 18.

The brace panel 14 is hingedly connected to the end panel 16 by a hinged connection in the form of a fold line 15. The brace panel 14 is hingedly connected to a second end of the end panel 16; the second end opposes a first end to which the front panel 18 is hingedly connected.

A securing panel 12 is hingedly connected to the brace panel 14 by a hinged connection in the form of a fold line 13. The securing panel 12 is hingedly connected to a second end of the brace panel 14; the second end opposes a first end to which the end panel 16 is hingedly connected.

Optionally, the securing panel 12 is tapered in shape. This may be achieved by chamfering or bevelling the corners of the securing panel 12. In the illustrated embodiment the corners are notched out or cutaway, the exterior corner thereby formed in rounded, the interior corner is filleted.

Turning to the construction of the packaging structure 90 as illustrated in FIG. 2, the display card 90 can be formed by a series of sequential folding operations. The folding process is not limited to that described below and may be altered according to particular manufacturing requirements.

The blank 10 is folded such that the securing panel 12 is brought into face contacting relationship with the front panel 18. In doing so the end panel 16 is folded with respect to the front panel 18 about fold line 17 so as to be divergently arranged with respect to the front panel 18. The brace panel 14 is folded with respect to the end panel 16 about fold line 15. The securing panel 12 is folded with respect to the brace panel 14 about fold line 13.

The blank 10 is folded such that the plurality of sleeve forming panels 20 are wrapped around a shaft S1 of the article P as shown in FIG. 4. The plurality of sleeve forming panels 20 form a sleeve about the shaft S1 of the article P.

The rear panel 22 is brought into overlying relationship with the front panel 12. The rear panel 22 is disposed substantially in registry with the front panel 12.

The securing panel 12 is located between the front panel 18 and the rear panel 22.

The rear panel 22 may overlie substantially all of the securing panel 12, such that the securing panel 12 is hidden from view.

The rear panel 22 is secured to the front panel 18 to form the display card 90 shown in FIGS. 2 and 3. In some embodiments this may be done by heat sealing or radio frequency (RF) sealing or welding. The substrate of the blank 10 may comprise a coating or layer on at least one side to provide a bonding surface which responds to such treatment. A bonding surface of the rear panel 22 is brought into face to face contacting relationship with a bonding surface of the front panel 18. In some embodiments the bonding coating or layer may also serve to provide a tear resistant layer.

In other embodiments glue or other adhesive treatment may be applied to the inner surface of the front or rear panels 18, 22 prior to bringing them into face contacting relationship.

The securing panel 12 is secured between the front panel 18 and the rear panel 22. In this way the end panel 16 is maintained at an angle to the front panel 18, in some embodiments this is an oblique angle. In other embodiments, the front panel 18 and end panel 16 are orthogonally arranged with respect to each other.

The brace panel 14, end panel 16 and a portion of the front panel define a first tubular structure having a triangular cross-sectional shape.

The plurality of sleeve forming panels 20 form a second tubular structure, the plurality of sleeve forming panels 20 approximate a cylinder.

Whilst the foregoing method of construction describes simultaneously forming a first tubular structure (from the end and brace panels 14, 16) together with a second tubular structure (from the plurality of sleeve forming panels 20), it will be appreciated that the first tubular structure may be formed prior to forming second tubular structure.

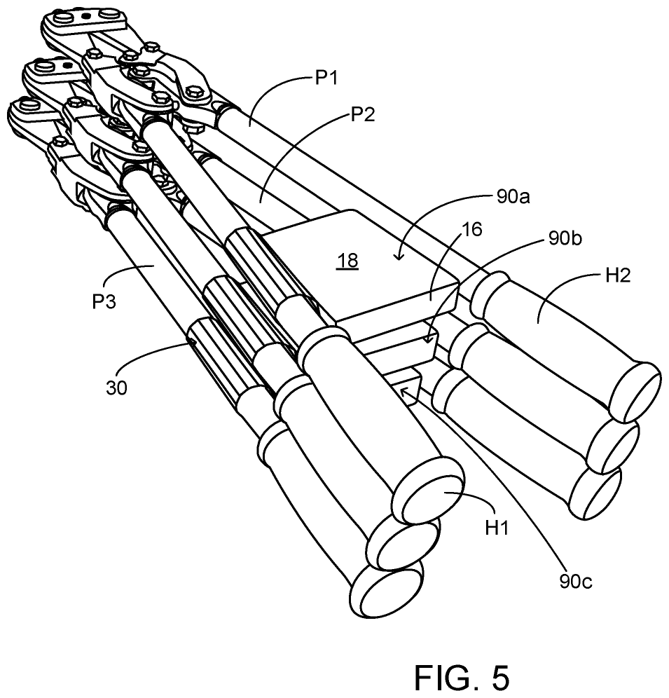

The packaged product 91 is shown in FIGS. 4 and 5. The front panel, rear panel and tubular structures form a billboard. The billboard is three dimensional, it comprises a plurality of differently oriented planes.

The plurality of sleeve forming panels 20 form a sleeve 30 about the first shaft of the product P. The front rear and end panels provide a tag or label for display of information. The display card 90 may comprise a security device such as but not limited to an RFID tag.

The display card 90 is arranged to be disposed between the first shaft S1 and a second shaft S2 of the product P. The first and second shafts S1, S2 form levers of the product. A cutting device is mounted to a first end of each of the first and second shafts S1, S2. The cutting device provides a first end stop. The first shaft S1 comprises a first handle H1 mounted to a second end of the first shaft S1. The second shaft S2 comprises a second handle H2 mounted to a second end of the second shaft S2. The first handle H1 provides a second end stop. The first shaft S1 and the first handle H1 form a first arm. The second shaft S2 and the second handle H2 form a second arm.

The sleeve 30 is dimensioned and arranged to form a close fit about the first shaft S1. The first and second end stops are dimensioned and/or arranged to prevent or at least inhibit the display card 90 from being separately or detached from the product P by sliding the sleeve 30 along the first shaft S1.

The first and second shafts S1, S2 may be divergently arranged with respect to each other. The front panel 18 and rear panel 22 may be tapered in shape so as to compliment the divergent relationship of the first and second shafts S1, S2.

The packaged product 91 shown in FIG. 4 may be readily inspected by a consumer at a point of sale of the product P. As the display card 90 is mounted to only one shaft S1. The consumer may inspect the product P, open and close the jaws of the hand tool P, even test the hand tool P. In other embodiments it may be desirable to prevent or restrict such activity, in these embodiments the display card 90 may be provided with a second plurality of sleeve forming panels (not shown). The second plurality of sleeve forming panels may be hinged at one end thereof to one of the front and rear panels 18, 22. The second plurality of sleeve forming panels may terminate in a second securing panel which in an erected condition is disposed between the front and rear panels 18, 22 and is secured therebetween. The second plurality of sleeve forming panels form a second sleeve (not shown) wrapped about the second shaft S2 of the product P. In this way the display card may prevent or restrict movement of the first and second shafts S1, S2 with respect to each other. The front and rear panel 18, 22 may define the position of the first and second shafts S1, S2 with respect to each other when the product P is on display at a point of sale. It will be appreciated that this may in turn define the condition of the jaws of the hand tool P, open or closed.

As shown in FIG. 5 the display card 90 is arranged such that a plurality of products P1, P2, P3 can be stacked or positioned in close proximity. The height of the end panel 16 may be arranged to be less than the height of the hand tool P1, P2, P3. The height of the end panel 16 may be arranged to be less than the diameter of the first shaft S1. In some embodiments, the height of the end panel 16 may be arranged to be less than the diameter of the sleeve 30. In other embodiments, the height of the end panel 16 may be arranged to be less than the diameter of the first and second handles H1, H2.

The display card 90 is located within a void or gap defined between the first and second shafts S1, S2. In this way the display card 90 does not increase the shelf space required to accommodate the product P1, P2, P3. Further, the display card 90 when mounted to one of the products P1, P2, P3 does not collide or interfere with the display card 90 mounted to an adjacently disposed product P1, P2, P3.

It will be appreciated that any or all of the panels 14, 16, 18, 20, 22 may provide surface for display of information.

The three-dimensional aspect of the display card 90, that is to say the non-planar relationship of the end panel 16 and brace panel 14 with respect to the front and rear panels 18, 22 create an information display which is viewable from multiple directions or viewpoints of a consumer or in multiple orientations of the product P.

The present disclosure provides a package 91 comprising a display card 90 mounted to a product P. The display card 90 comprises a front panel 18, a rear panel 22 and a pair of easel panels 14, 16 formed from the end panel 16 and the brace panel 14. The pair of easel panels 14, 16 together with at least one of the front and rear panels 18, 22 form a first tubular structure for information display. The product P may comprise a pair of arms, each arm may comprise a shaft S1, S2 and a handle H1, H2. The display card 90 may be mounted to at least one of the arms. The display card 90 may be mounted between the pair of arms. The display card 90 may comprise a second tubular structure disposed about said at least one arm. The second tubular structure may be formed from a plurality of sleeve panels 20 which in an erected condition form a tubular structure or sleeve 30 having a cross-sectional shape approximating the cross-sectional shape of said at least one arm. The second tubular structure may be mounted on said at least one arm between a pair of end stops for inhibiting removal of the display card 90 from the product P.

The first and second tubular structures may be secured in an erected condition simultaneously by securing the front and rear panels 18, 22 together. At least one of the first and second tubular structures may comprise a securing panel 12 secured between front and rear panels 18, 22. In some embodiments at least one of the first and second tubular structures may be hingedly connected to each of the front and rear panels 18, 22. At least one of the first and second tubular structures may comprise a plurality of panels, a first end of the plurality of panels may be hingedly connected to the front panel and a second end of the plurality of panels may be hingedly connected to the rear panel.

It can be appreciated that various changes may be made within the scope of the present invention. For example, the size and shape of the panels may be adjusted to accommodate articles of differing size or shape. It will be appreciated that while the present disclosure is to a display card formed from a single blank, the display card may be formed from two or more blanks. In such embodiments one or both of the tubular structures may be formed from a separate blank, having a pair of securing panels for being secured between the front and rear panels to enable said tubular structures to be held in an erected condition. In some embodiments the front and rear panels may be hingedly connected to each other directly, each of the tubular structures will comprise at least one securing panel.

It will be recognised that as used herein, directional references such as “top”, “bottom”, “base”, “front”, “back”, “end”, “side”, “inner”, “outer”, “upper” and “lower” do not necessarily limit the respective panels to such orientation, but may merely serve to distinguish these panels from one another.

As used herein, the terms “hinged connection” and “fold line” refer to all manner of lines that define hinge features of the blank, facilitate folding portions of the blank with respect to one another, or otherwise indicate optimal panel folding locations for the blank. Any reference to “hinged connection” should not be construed as necessarily referring to a single fold line only; indeed, a hinged connection can be formed from two or more fold lines wherein each of the two or more fold lines may be either straight/linear or curved/curvilinear in shape. When linear fold lines form a hinged connection, they may be disposed parallel with each other or be slightly angled with respect to each other. When curvilinear fold lines form a hinged connection, they may intersect each other to define a shaped panel within the area surrounded by the curvilinear fold lines. A typical example of such a hinged connection may comprise a pair of arched or arcuate fold lines intersecting at two points such that they define an elliptical panel therebetween. A hinged connection may be formed from one or more linear fold lines and one or more curvilinear fold lines. A typical example of such a hinged connection may comprise a combination of a linear fold line and an arched or arcuate fold line which intersect at two points such that they define a half moon-shaped panel therebetween.

As used herein, the term “fold line” may refer to one of the following: a scored line, an embossed line, a debossed line, a line of perforations, a line of short slits, a line of half-cuts, a single half-cut, an interrupted cutline, a line of aligned slits, a line of scores and any combination of the aforesaid options.

It should be understood that hinged connections and fold lines can each include elements that are formed in the substrate of the blank including perforations, a line of perforations, a line of short slits, a line of half-cuts, a single half-cut, a cutline, an interrupted cutline, slits, scores, any combination thereof, and the like. The elements can be dimensioned and arranged to provide the desired functionality. For example, a line of perforations can be dimensioned or designed with degrees of weakness to define a fold line and/or a severance line. The line of perforations can be designed to facilitate folding and resist breaking, to facilitate folding and facilitate breaking with more effort, or to facilitate breaking with little effort.

The phrase “in registry with” as used herein refers to the alignment of two or more elements in an erected carton, such as an aperture formed in a first of two overlapping panels and a second aperture formed in a second of two overlapping panels. Those elements in registry with each other may be aligned with each other in the direction of the thickness of the overlapping panels. For example, when an aperture in a first panel is “in registry with” a second aperture in a second panel that is placed in an overlapping arrangement with the first panel, an edge of the aperture may extend along at least a portion of an edge of the second aperture and may be aligned, in the direction of the thickness of the first and second panels, with the second aperture.

1. A package comprising a display card mounted to a product, wherein the display card comprises a front panel, a rear panel and a pair of easel panels, the pair of easel panels together with at least one of the front and rear panels form a first tubular structure for information display, and wherein the product comprises at least one arm and the display card comprises at least one second tubular structure mounted to said at least one arm.

2. A package according to claim 1 wherein the at least one second tubular structure is disposed about the at least one arm so as to substantially encircle the least one arm.

3. A package according to claim 1 wherein the at least one arm comprises a shaft and a handle.

4. A package according to claim 1 wherein the product comprises a pair of arms.

5. A package according to claim 4 wherein the display card is mounted to at least one of the arms of the pair of arms.

6. A package according to claim 4 wherein the display card is mounted between the pair of arms.

7. A package according to claim 1 wherein the at least one second tubular structure is formed from a plurality of sleeve panels which in an erected condition form a tube having a cross-sectional shape approximating the cross-sectional shape of the at least one arm.

8. A package according to claim 1 wherein the at least one second tubular structure is mounted on the at least one arm between a pair of end stops so as to inhibit removal of the display card from the product.

9. A package according to claim 1 wherein the pair of easel panels comprises an end panel and a brace panel.

10. A package according to claim 9 wherein the end panel is hingedly connected to the brace panel.

11. A package according to claim 1 wherein the first and second tubular structures are secured in an erected condition simultaneously by securing the front and rear panels together.

12. A package according to claim 1 wherein at least one of the first and second tubular structures comprises a securing panel secured between front and rear panels.

13. A package according to claim 1 wherein the first tubular structure comprises at least one securing panel secured between front and rear panels.

14. A package according to claim 9 wherein the display card comprises a securing panel hingedly connected to the brace panel.

15. A package according to claim 1 wherein at least one of the first and second tubular structures is hingedly connected to each of the front and rear panels.

16. A package according to claim 1 wherein at least one of the first and second tubular structures comprises a plurality of panels, and wherein a first end of the plurality of panels is hingedly connected to the front panel and a second end of the plurality of panels is hingedly connected to the rear panel.

17. A blank for forming a display card, the blank comprises a plurality of panels including a front panel, a rear panel and a pair of easel panels, the pair of easel panels together with at least one of the front and rear panels arranged to form a first tubular structure for information display in a setup condition and wherein the blank comprises a plurality of sleeve forming panels for forming at least one second tubular structure.

18. A blank according to claim 17 wherein the plurality of sleeve forming panels are hingedly connected in a linear series.

19. A blank according to claim 17 wherein the plurality of sleeve forming panels are hingedly connected to at least one of the front and rear panels.

20. A blank according to claim 17 wherein the plurality of sleeve forming panels are hingedly connected to each of the front and rear panels.

21. A blank according to claim 17 wherein the plurality of sleeve forming panels interconnect the front and rear panels.

22. A blank according to claim 17 wherein the plurality of sleeve forming panels are hingedly connected to at least one of the front and rear panels along a first edge thereof and the pair of easel panels are hingedly connected to said one of the front and rear panels along a second adjacent edge thereof.

23. A blank according to claim 17 wherein a first one of the pair of easel panels is hingedly connected to at least one of the front and rear panels.

24. A blank according to claim 17 wherein a second one of the pair of easel panels is hingedly connected to a securing panel.

25. A blank according to claim 17 formed from a paperboard substrate having a tear resistant layer.

26. A package according to claim 1 the product is a pair of bolt cutters.
